(19) United States
(12) Patent Application Publication
(10) Pub. No.: US 2025/0243432 A1
(43) Pub. Date: Jul. 31, 2025

(54) NOVEL CLEANING SOLUTION CONTAINING TRICHLOROETHANOL, DIOXOLANES, OR CARBONATES

(71) Applicant: Illinois Tool Works Inc., Glenview, IL (US)

(72) Inventors: Paul Blair, Jonesboro, GA (US); Zhihong Ye, Lilburn, GA (US)

(21) Appl. No.: 19/029,609

(22) Filed: Jan. 17, 2025

Related U.S. Application Data
(60) Provisional application No. 63/626,925, filed on Jan. 30, 2024.
(60) Provisional application No. 63/670,522, filed on Jul. 12, 2024.

(51) Int. Cl. C11D 3/24; C11D 1/76; C11D 3/30; C11D 3/43; C11D 17/00

(52) U.S. Cl. CPC C11D 3/24; C11D 1/76; C11D 3/30; C11D 3/43; C11D 17/0017

(57) ABSTRACT

The present disclosure relates generally to a cleaning solution comprising 2,2,2-trichloroethanol as a solvent (or a co-solvent). The cleaning solvent may further comprise a second co-solvent, water, or both. The cleaning solution may biphasic with a first phase that is water-rich and a second phase that is solvent-rich. The cleaning solvent may contain other components, such as an emulsifying surfactant, a spreading and wetting surfactant, phosphonic acid and an amine. In certain embodiments, a dioxolane or a carbonate may be used as a co-solvent either instead of, or in addition to, 2,2,2-trichloroethanol.

### CROSS-REFERENCE TO RELATED APPLICATION

This application claims priority to, and the benefit of, U.S. Provisional Application No. 63/626,925, titled “NOVEL CLEANING SOLUTION CONTAINING TRICHLOROETHANOL,” filed Jan. 30, 2024, and Provisional Application No. 63/670,522, titled “NOVEL CLEANING SOLUTION CONTAINING TRICHLOROETHANOL, DIOXOLANES, OR CARBONATES”, filed Jul. 12, 2024, both of which are herein incorporated by reference in their entirety.

### FIELD

The present disclosure relates generally to a cleaning solution comprising 2,2,2-trichloroethanol as a solvent or co-solvent.

### BACKGROUND

In-line cleaning is a method of cleaning in which assemblies are processed continuously on a conveyor system and cleaning cycle times are controlled by the conveyor speed. As printed circuit board (PCB) manufacturers continue to look for increased cleaning and drying performance while maintaining process capability and flexibility, in-line cleaners continue to be the industry solution for high volume production. In-line cleaners may be used for de-fluxing, including de-fluxing of PCBs. Some fluxes are difficult to remove, particularly from surface mount devices where the gap between the surface mount device and the PCB may be less than 1 mm, so it can be difficult to get the cleaning solution in to such a gap and out again.

In-line cleaners are typically-water based and may be prepared from a cleaning concentrate. Strong industrial cleaners that are currently available may contain a solvent such as percloroethylene (PERC), trans-1.2-dichloroethylene, trichloroethylene (TCE) or methylene chloride. While such solvents may be effective, they are often toxic (e.g., percloroethylene) or do not dissolve in water (e.g., trans-1.2-dichloroethylene). In-line cleaners may comprise a co-solvent (such as glycol ether) and an amine (because fluxes are typically acidic). Often, in-line cleaners are alkaline with a pH between 9 and 12.

There exists a need for an in-line cleaner that is effective and non-toxic with a neutral or close-to-neutral pH.

### SUMMARY

According to an aspect of the present disclosure, a cleaning solution may comprise 2,2,2-trichloroethanol as a solvent. The cleaning solution may further comprise water. The cleaning solution may be biphasic with a first phase that is water-rich and a second phase that is solvent-rich. The cleaning solution may further comprise an emulsifying surfactant. The cleaning solution may further comprise a spreading and wetting surfactant, such as an acetylenic surfactant. The cleaning solution may further comprise an amine such as a primary, secondary, tertiary amine, polyamine or a primary or secondary alkanolamine, including a 6 to 10 carbon alkanolamine.

According to another aspect of the present disclosure, a cleaning solution may comprise 2,2,2-trichloroethanol as a first co-solvent and a second co-solvent that is different from the first co-solvent. The second co-solvent may be a propylene glycol ether, an ethylene glycol ether, a dioxolane derivative, dioxane, alcohol or halogenated alcohol. The cleaning solution may further comprise water. The cleaning solution may be biphasic with a first phase that is water-rich and a second phase that is solvent-rich. The cleaning solution may further comprise an emulsifying surfactant. The cleaning solution may further comprise a spreading and wetting surfactant, such as an acetylenic surfactant. The cleaning solution may further comprise an amine such as a primary, secondary, tertiary amine, or polyamine or a primary or secondary alkanolamine, including a 6 to 10 carbon alkanolamine.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

The following is a description of the examples depicted in the accompanying drawings. The figures are not necessarily to scale, and certain features and certain views of the FIGURE may be exaggerated in scale or in schematic for clarity or conciseness.

FIG. 1 illustrates a skeletal structural formula of 2,2,2-trichloroethanol.

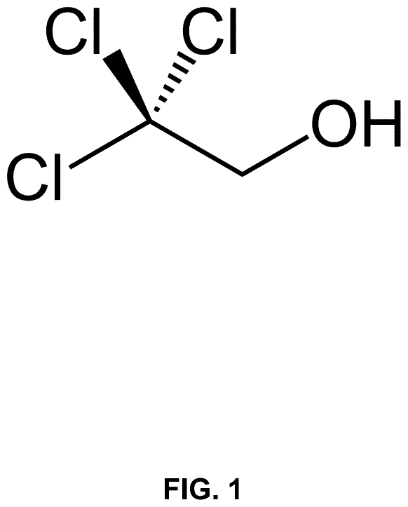

The foregoing summary, as well as the following detailed description, will be better understood when read in conjunction with the figures. It should be understood that the claims are not limited to the arrangements and instrumentality shown in the FIGURE. Furthermore, the appearance shown in the FIGURE is one of many ornamental appearances that can be employed to achieve the stated functions of the apparatus.

### DETAILED DESCRIPTION

In the following detailed description, specific details may be set forth to provide a thorough understanding of the embodiments of the present disclosure. However, it will be clear to one skilled in the art when disclosed examples may be practiced without some or all of these specific details. For the sake of brevity, well-known features or processes may not be described in detail. In addition, like or identical reference numerals may be used to identify common or similar elements.

One or more specific embodiments of the present disclosure will be described below. In an effort to provide a concise description of these embodiments, all features with an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

This present disclosure relates generally to a cleaning solution comprising 2,2,2-trichloroethanol (CAS 115-20-8) as a solvent or co-solvent. Advantages of using 2,2,2-trichloroethanol is that it is a small, dense molecule that can provide an extra impact during cleaning (e.g., by providing a molecular ballistic effect on the contamination being removed), that it is non-toxic, and that it is partially water soluble.

A cleaning solution according to the present disclosure may further comprise a second co-solvent that is not 2,2,2-trichloroethanol. For example, the second co-solvent may be a propylene glycol ether, an ethylene glycol ether, a dioxolane derivative, or an alcohol. In some embodiments, the second co-solvent may be γ-butyrolactone. In other embodiments, the second co-solvent may be solketal or 1.4 dioxane. Because 2,2,2-trichloroethanol is partially water-soluble, a second co-solvent can be particularly useful.

In some embodiments, a cleaning solution according to the present disclosure may include at least one dioxolane or a dioxolane derivative including halogenated dioxolanes such as 2-trifluoromethyl-1,3-dioxolane: 2-chloromethyl-1,3-dioxolane (CAS #2568-30-1), 2-bromomethyl-1,3-dioxolane, 4-fluoro-1,3-dioxolane, 4-(trifluormethyl)-1,3-dioxolane (CAS #114435-02-8), or 2,2-bis(trifluoromethyl)-1.3-dioxolane (CAS #1765-26-0).

In some embodiments, a cleaning solution according to the present disclosure may include a class of compounds with water solvency and halogenation, which exist as heterocyclic rings and linear molecules such as: 3,3,3-trifluoropropylene carbonate (CAS #167951-80-6), 4-fluoro ethylene carbonate, hexafluoroisopropylmethyl carbonate (CAS 13171-18-1; 607382-52-5), and 2,2,2-trifluoroethyl methyl carbonate (CAS 156783-95-8). Carbonates without halogenation are also included in this disclosure, such as: dimethyl carbonate, methyl ethyl carbonate, ethylene carbonate, and propylene carbonate.

Some of the compounds discussed above are found in lithium battery electrolyte compositions, however, their use as cleaning solvents has not been previously established.

A cleaning solution according to the present disclosure may further comprise water. The water may be deionized water. The cleaning solution may be biphasic with a first phase that is water-rich and a second phase that is solvent-rich. The cleaning solution may be a semi-stable two-phase system that may partially separate but that disperses cleanly.

In certain embodiments, a particular pair of co-solvents may be preferred. For example, dipropylene n-butyl glycol ether may be used as a first co-solvent with dipropylene n-propyl glycol ether as a second co-solvent. In another example, hexyl diethylene glycol ether may be used as a first co-solvent with methyl diethylene glycol ether as a second co-solvent.

In certain embodiments, a cleaning solution according to the present disclosure may further comprise an emulsifying surfactant. In some embodiments, the emulsifying surfactant may be alkyl ethoxylates sodium or ammonium lauryl or laureth sulphate.

In certain embodiments, a cleaning solution according to the present disclosure may further comprise a spreading and wetting surfactant. In some embodiments, the spreading and wetting surfactant may be an acetylenic surfactant. In other embodiments, the spreading and wetting surfactant may be siloxanes.

In certain embodiments, a cleaning solution according to the present disclosure may further comprise an amine. In some embodiments, the amine may be a primary, secondary, or tertiary amine. In other embodiments, the amine may be a primary or secondary alkanolamine, including a 6 to 10 carbon alkanolamine. In other embodiments, the amine may be a polyamine.

In certain embodiments, a cleaning solution according to the present disclosure may further comprise a phosphate or an organo phosphonic acid. In some embodiments, the phosphate may be a 4 to 10 carbon phosphoric phosphonic acid. In other embodiments, the phosphate may be a dialkyl phosphate.

In certain embodiments, a cleaning solution according to the present disclosure may be non-toxic and have a pH between 7 and 9, or between 7 and 8, or between 7.2 and 7.8. Neutral pH cleaners with a pH of 7 (or close-to-neutral pH cleaners with a pH close to 7) tend to be gentler on metal parts and PCBs, and tend to be better from a waste perspective since such cleaners do not have to be neutralized before disposal.

In certain embodiments, a cleaning solution according to the present disclosure may be prepared as a concentrated solution that is then diluted to comprise 5-50%, or 10-30%, or 10-20% 2,2,2-trichloroethanol. In some embodiments that contain a second co-solvent, the cleaning solution may be prepared as a concentrated solution that is then diluted to comprise 5-50%, or 10-30%, or 10-20% of the second co-solvent.

A cleaning solution according to the present disclosure may be used as an in-line cleaner, for example for cleaning printed circuit boards (PCBs). A concentrated form of the cleaning solution may be diluted in an in-line cleaning machine and then sprayed onto a PCB. The PCB is then rinsed and then dried. To get underneath surface mounted components and into other tight crevices of PCBs, the cleaning solution may be atomized then sprayed on.

Dynamic surface tension may be important for adequate cleaning, which may mean that the cleaning solution needs to contain a spreading and wetting surfactant. For example, droplets of atomized cleaning solution may need to contact more than four times as much surface area once underneath a PCB component.

A cleaning solution according to the present disclosure may be effective for ultrasonic cleaning as presented or diluted in a standalone ultrasonic bath. Or ultrasonic cleaning with a vapor degreasing solvent that boils and condenses onto a part to be cleaned, which can wash any contamination off. For stubborn, hard-to-remove chemistries, a part to be cleaned may be immersed in a boiling cleaning solution in order to get directed agitation from both solvent and heat. Sometimes the cold sump (where condensed liquid is captured and returned) may have ultrasonic capabilities. Typically, the boiling point of 2,2,2-trichloroethanol will be higher than the boiling point of a degreasing solution so it remains in the boil sump and removes stubborn contamination when the part is immersed in the boil sump or ultrasonically equipped cold sump.

The various aspects and embodiments disclosed herein are not intended to be limiting. Other embodiments may be utilized, and other changes may be made, without departing from the spirit or scope of the subject matter presented herein. It will be readily understood that the aspects of the present disclosure, as generally described herein and illustrated in the FIGURE, can be arranged, substituted, combined, separated, and designed in a wide variety of different configurations, all of which are contemplated herein.

1. A cleaning solution comprising 2,2,2-trichloroethanol as a solvent.

2. The cleaning solution of claim 1, further comprising water.

3. The cleaning solution of claim 2, wherein the cleaning solution is biphasic with a first phase that is water-rich and a second phase that is solvent-rich.

4. The cleaning solution of claim 1, further comprising an emulsifying surfactant.

5. The cleaning solution of claim 1, further comprising a spreading and wetting surfactant.

6. The cleaning solution of claim 5, wherein the spreading and wetting surfactant is an acetylenic surfactant.

7. The cleaning solution of claim 1, further comprising an amine.

8. The cleaning solution of claim 7, wherein the amine is a primary, secondary, tertiary amine or polyamine.

9. The cleaning solution of claim 8, wherein the amine is a primary or secondary alkanolamine.

10. The cleaning solution of claim 9, wherein the amine is a 6 to 10 carbon alkanolamine.

11. A cleaning solution comprising:
2,2,2-trichloroethanol as a first co-solvent; and
a second co-solvent that is different from the first co-solvent.

12. The cleaning solution of claim 11, further comprising water.

13. The cleaning solution of claim 12, wherein the cleaning solution is biphasic with a first phase that is water-rich and a second phase that is solvent-rich.

14. The cleaning solution of claim 11, wherein the second co-solvent is a propylene glycol ether, an ethylene glycol ether, a dioxolane derivative, solketal, dioxane or an alcohol.

15. The cleaning solution of claim 11, further comprising an emulsifying surfactant.

16. The cleaning solution of claim 11, further comprising a spreading and wetting surfactant.

17. The cleaning solution of claim 16, wherein the spreading and wetting surfactant is an acetylenic surfactant.

18. The cleaning solution of claim 11, further comprising an amine.

19. The cleaning solution of claim 18, wherein the amine is a primary, secondary, tertiary amine or polyamine.

20. The cleaning solution of claim 18, wherein the amine is a primary or secondary alkanolamine.

21. The cleaning solution of claim 20, wherein the amine is a 6 to 10 carbon alkanolamine.

22. The cleaning solution of claim 11, wherein the second co-solvent is:
2-trifluoromethyl-1,3-dioxolane,
2-chloromethyl-1,3-dioxolane (CAS #2568-30-1),
2-bromomethyl-1,3-dioxolane,
4-fluoro-1,3-dioxolane,
4-(trifluormethyl)-1,3-dioxolane (CAS #114435-02-8),
2,2-bis(trifluoromethyl)-1.3-dioxolane (CAS #1765-26-0),
3,3,3-trifluoropropylene carbonate (CAS #167951-80-6),
4-fluoro ethylene carbonate,
hexafluoroisopropylmethyl carbonate (CAS 13171-18-1; 607382-52-5),
2,2,2-trifluoroethyl methyl carbonate (CAS 156783-95-8),
dimethyl carbonate,
methyl ethyl carbonate,
ethylene carbonate, or
propylene carbonate.

23. A cleaning solution comprising a first co-solvent and a second co-solvent, wherein the first and second co-solvents are different, and wherein the first co-solvent is chosen from the following group of solvents:
2-trifluoromethyl-1,3-dioxolane,
2-chloromethyl-1,3-dioxolane (CAS #2568-30-1),
2-bromomethyl-1,3-dioxolane,
4-fluoro-1,3-dioxolane,
4-(trifluormethyl)-1,3-dioxolane (CAS #114435-02-8),
2,2-bis(trifluoromethyl)-1.3-dioxolane (CAS #1765-26-0),
3,3,3-trifluoropropylene carbonate (CAS #167951-80-6),
4-fluoro ethylene carbonate,
hexafluoroisopropylmethyl carbonate (CAS 13171-18-1; 607382-52-5),
2,2,2-trifluoroethyl methyl carbonate (CAS 156783-95-8),
dimethyl carbonate,
methyl ethyl carbonate,
ethylene carbonate, and
propylene carbonate.

24. The cleaning solution of claim 23, wherein the second co-solvent is chosen from the following group of solvents:
2-trifluoromethyl-1,3-dioxolane,
2-chloromethyl-1,3-dioxolane (CAS #2568-30-1),
2-bromomethyl-1,3-dioxolane,
4-fluoro-1,3-dioxolane,
4-(trifluormethyl)-1,3-dioxolane (CAS #114435-02-8),
2,2-bis(trifluoromethyl)-1.3-dioxolane (CAS #1765-26-0),
3,3,3-trifluoropropylene carbonate (CAS #167951-80-6),
4-fluoro ethylene carbonate,
hexafluoroisopropylmethyl carbonate (CAS 13171-18-1; 607382-52-5),
2,2,2-trifluoroethyl methyl carbonate (CAS 156783-95-8),
dimethyl carbonate,
methyl ethyl carbonate,
ethylene carbonate, and
propylene carbonate.
